(19) United States
(12) Patent Application Publication
(10) Pub. No.: US 2026/0213411 A1
(43) Pub. Date: Jul. 23, 2026

(54) ANTENNA, MOBILE COMMUNICATION BASE STATION AS WELL AS USER DEVICE

(71) Applicant: Telefonaktiebolaget LM Ericsson (publ), Stockholm (SE)

(72) Inventor: Bruno Gomes, Rosenheim (DE)

(21) Appl. No.: 19/158,140

(22) PCT Filed: Mar. 2, 2023
(86) PCT No.: PCT/EP2023/055305

§ 371 Date: Aug. 20, 2025

(51) Int. Cl. H01Q 5/378; H01Q 1/24; H01Q 9/16; H01Q 19/10; H01Q 21/24

(52) U.S. Cl. CPC H01Q 5/378; H01Q 1/246; H01Q 9/16; H01Q 19/10; H01Q 21/24

(57) ABSTRACT

An antenna, in particular for a mobile communication base station, has a first radiator, a second radiator and at least one spatial filter. At least one spatial filter is a part of the first radiator, of a reflector of the antenna and/or of a tuning element of the antenna. The at least one spatial filter comprises a conductor and filter unit cells as part of the conductor, the filter unit cells comprising a first arm, a second arm, an inductive line and a capacitor, wherein the inductive line is located in the first arm and the capacitor is located in the second arm. Further, a mobile communication base station and a user device are shown.

### TECHNICAL FIELD

The invention relates to an antenna, a mobile communication base station as well as to a user device.

### BACKGROUND

Multiband antennas are known in the art. In such antennas, a first array of first radiators designed for a first frequency band is interleaved with a second array of second radiators designed for a second frequency band. It is desirable that the radiators of the arrays have no influence on each other.

However, in order to achieve a very compact size, the radiators of the second array are arranged partly below the radiators of the first array. In other words, seen in a top view onto the antenna, i.e. against the radiation direction, the second radiators are partly covered by the first radiators.

Thus, the beam quality of the second array is deteriorated by the presence of the first array.

Attempts have therefore been made to increase the transparency of the first radiators in the frequency band of the second array by providing spatial filters composed of serial resonant circuits, for example in US2020/0127389A1 and CN112821044.

However, the solutions work only in a narrow frequency band.

### SUMMARY

It is an object of the invention to provide an antenna, a base station as well as a user device having an improved beam quality of the beam of the second array due to an increased transparency of the components of the first array.

For this purpose, in an embodiment, an antenna in particular for a mobile communication base station is provided. The antenna comprises at least one first radiator for a first frequency band, at least one second radiator for a second frequency band and at least one spatial filter. At least one of the at least one spatial filter is a part of the at least one first radiator, at least one of the at least one spatial filter is part of a reflector of the antenna and/or at least one of the at least one spatial filter is part of a tuning element of the antenna. The at least one spatial filter comprises a conductor and filter unit cells as part of the conductor, the filter unit cells comprising a first arm, a second arm, an inductive line and a capacitor, wherein the inductive line is located in the first arm and the capacitor is located in the second arm.

By the use of spatial filters composed of an inductance and a capacitance in parallel, multiple resonances are generated leading to an increased transparency in different frequency bands. Thus, the bandwidth of the transparency is increased.

For example, the inductance of the inductive line controls the transparency in a lower frequency range, while the capacitance of the capacitor controls the transparency in a higher frequency range. Further, the interaction between inductive and capacitive regions generate improvements in the middle of both bands, improving the overall performance.

For example, the first arm and the second arm are electrically parallel to one another. The remaining conductor is in particular a single electric line.

In an aspect, the first arm and the second arm are both electrically connected, in particular galvanically coupled, to the conductor.

In an embodiment, the filter unit cells are arranged in series on the conductor so that the effect of the unit cells accumulates.

For a further improved transparency, the conductor may form a loop, in particular a closed loop.

In an embodiment, the inductive line has a wave shape, in particular a sine wave shape or a digital square wave shape, allowing to provide a high inductance using little space.

For example, the wave shape has an amplitude and a periodicity. The amplitude may be between 4 mm and 5 mm. The wave shape may have a periodicity in the range of 3 to 5 periods per filter unit cell.

In an aspect, the capacitor is a parallel plate capacitor or an interdigital capacitor, providing easy to manufacture capacitors.

In order to further improve the inductance of the first arm, a projection of the first arm may extend into the capacitor in the second arm, in particular wherein the projection is located in the middle of the first arm.

Reducing manufacturing costs further, the spatial filter may comprise or may be made of a single metal piece, in particular a stamped sheet metal part.

In an embodiment, the spatial filter comprises a filter carrier being a dielectric, in particular a foil, a printed circuit board or a thermoplastic part, allowing precise shapes of the components of the spatial filters.

For example, the filter unit cells of the same spatial filter are arranged on the same surface or layer of the filter carrier, simplifying manufacture further.

In an aspect, the filter carrier has at least two surfaces or layers, wherein filter unit cells of the same spatial filter are arranged on both of the surfaces or layers and/or the conductor of the spatial filter is arranged on both surfaces or layers. This way, for example, the conductor may be provided with capacitances.

For example, the sections of the conductor on different surfaces are electrically connected through the filter carrier, e.g. by a capacitive coupling.

The filter unit cells may be arranged on the two surfaces or layers in alternating fashion.

In an aspect, the filter unit cells of the same spatial filter are identical or different from one another allowing an increased transparency or a broader bandwidth for the transparency.

In an embodiment, the at least one first radiator comprises at least one, in particular two or four radiating structures, wherein the radiating structures comprise one of the at least one spatial filter, in particular the one of the at least one spatial filter forms the respective radiating structure. This way, the first radiators become transparent without additional structures or metallizations.

For example, each radiating structure comprises at least one spatial filter. The at least one first radiator may be a dual-polarized radiator.

In an embodiment, the tuning element is a parasitic decoupling element, in partic arranged above the at least one first radiator, and/or a decoupling element, in particular arranged between adjacent ones of the first radiators. This way, tuning elements may interfere only with the electromagnetic waves in the intended frequency band, e.g. the first frequency band.

For example, “above” meaning the side of the first radiator facing away from the reflector. The parasitic decoupling element may be located centrally above the respective radiator.

In an embodiment, the antenna comprises a plurality of first radiators mounted to the reflector forming a first array and/or a plurality of second radiators mounted to the reflector forming a second array.

For the above mentioned purpose, in an embodiment, further a mobile communication base station is provided, the base station having at least one antenna as described above.

Further, for the above mentioned purpose, in an embodiment, a user device for mobile communication is provided having at least one antenna as described above.

The features and advantages described with respect to the antenna also apply to the base station and/or the user device and vice versa.

### BRIEF DESCRIPTION OF THE DRAWINGS

FIG. 1 shows a mobile communication base station according to an embodiment of the invention with an antenna according to an embodiment of the invention and a user device according to an embodiment of the invention with an antenna according to an embodiment of the invention,

FIG. 2 shows an enlarged view of an antenna according to FIG. 1,

FIG. 3 shows a top view of a radiator head of a first radiator of the antenna according to FIG. 2,

FIG. 4 shows an enlarged view of a filter unit cell of the radiator head of FIG. 3,

FIG. 5 shows an enlarged view of a decoupling element of the antenna according to FIG. 2,

FIGS. 6, 7 show enlarged views of a filter unit cell of the radiator head of further embodiments of antennas according to the invention,

FIG. 8 shows a top view of a radiator head of a first radiator of a further embodiment of an antenna according to the invention,

FIGS. 9, 10 show a top view and a bottom view, respectively, of a radiator head of a first radiator of a further embodiment of an antenna according to the invention, and

FIG. 11 shows a perspective view of a radiator head and a parasitic decoupling element of a first radiator of a further embodiment of an antenna according to the invention.

### DETAILED DESCRIPTION

FIG. 1 shows an embodiment of a mobile communication base station 10 and an embodiment of a user device 12.

The mobile communication base station 10 has a plurality of antennas 14 for providing speech and data connections to user devices. Mobile communication base stations 10 are also referred to as mobile communication cell sites.

The mobile communication base station 10 may be an access network node of a radio access network of a telecommunication network, or any other similar 3rd Generation Partnership Project (3GPP) access nodes or non-3GPP access points.

Moreover, as will be appreciated by those of skill in the art, an access a network node is not necessarily limited to an implementation in which a radio portion and a baseband portion are supplied and integrated by a single vendor. Thus, it will be understood that network nodes include disaggregated implementations or portions thereof.

For example, in some embodiments, the mobile communication base station 10 is an Open-RAN (ORAN) network node. An ORAN network node is a node in the telecommunication network that supports an ORAN specification (e.g., a specification published by the O-RAN Alliance, or any similar organization) and may operate alone or together with other nodes to implement one or more functionalities of any node in the telecommunication network, including one or more network nodes and/or core network nodes.

Examples of an ORAN network node include an open radio unit (O-RU), an open distributed unit (O-DU), and an open central unit (O-CU).

The antenna 14 of the mobile communication base station 10 is a multiband antenna to provide speech and data connections in various frequency bands.

The user device 12 has an antenna 16 and may be a mobile phone, a laptop computer, a customer premises equipment (CPE) or the like. The antenna 16 of the user device 12 is also a multiband antenna allowing a speech and/or data connection to the mobile communication base station 10 and/or to a communication satellite.

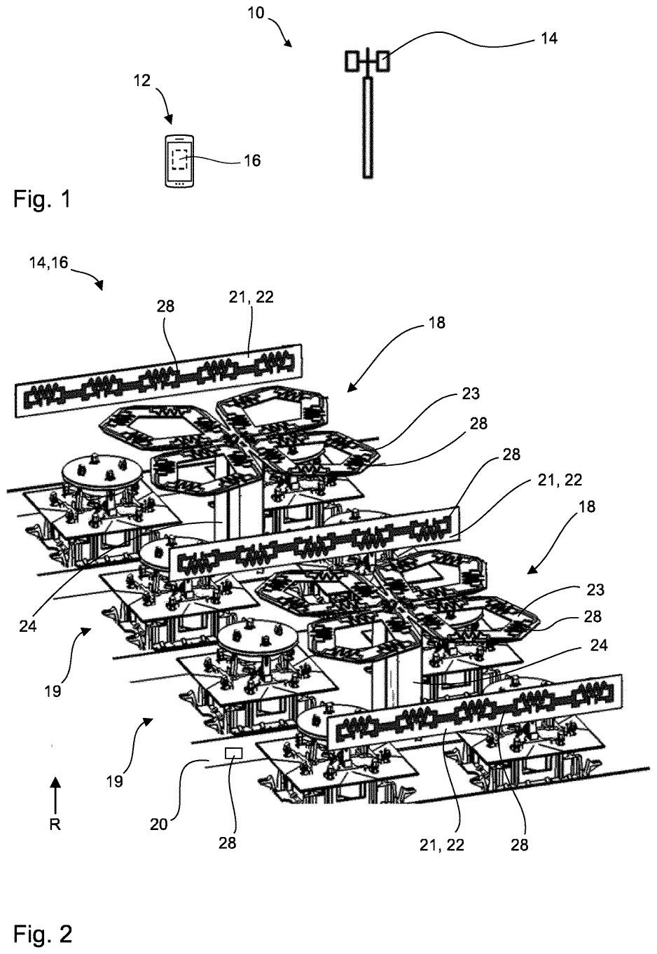

As shown in FIG. 2, exemplarily depicting radiators for a mobile communication base station 10, both antennas 14, 16 have a plurality of first electromagnetic radiators 18, a plurality of second radiators 19, a common reflector 20 and a plurality of tuning elements 21.

The first radiators 18 (called first radiators 18 only for differentiation) form a first array designed for a first frequency band. Thus, the first radiators 18 are designed to transmit and receive electromagnetic waves in the first frequency band.

Likewise, the second radiators 19 form a second array for a second frequency band. Thus, the second radiators 19 are designed to transmit and receive electromagnetic waves in a second frequency band.

The first radiators 18, in particular the first array, and the second radiators 19, in particular the second array, are interleaved with one another.

The first frequency band lies below the second frequency band, in particular fully, i.e. not overlapping with the second frequency band.

For example, the first frequency band is 600 MHz to 960 MHz and the second frequency band lies above 1.0 GHz, is in particular 1.4 to 2.6 GHz or 3.2 GHZ to 4.2 GHZ.

The first radiators 18 and the second radiators 19 are mounted on the reflector 20, serving as the common reflector for all types of radiators 18, 19.

Further, three tuning elements 21 in form of decoupling elements 22 are shown in FIG. 2. The decoupling elements 22 are arranged between adjacent ones of the first radiators 18 or at the end of a column of first radiators 18. Thus, each first radiator 18 is located between two of the decoupling elements 22.

The decoupling elements 22 are provided to avoid undesired coupling between adjacent first radiators 18 in the first frequency band.

The decoupling elements 22 are mounted below the radiators heads 23 of the first radiators 18.

Directional terms like “up”, “down”, “above”, “vertical”, etc. are to be understood with respect to the radiation direction R of the radiator (also referred to as “vertical”). “Sideways” or “horizontal” is to be understood as a direction perpendicular to the radiation direction R.

It is also conceivable that the decoupling elements 22 are mounted to the reflector 20.

The first radiators 18 comprise a radiator head 23 and two supports 24 each.

The radiator head 23 is mounted to the reflector 20 by the supports 24 as per se known in the art.

The radiator head 23 comprises a head carrier 25 and four radiation structures 26 applied to the head carrier 25.

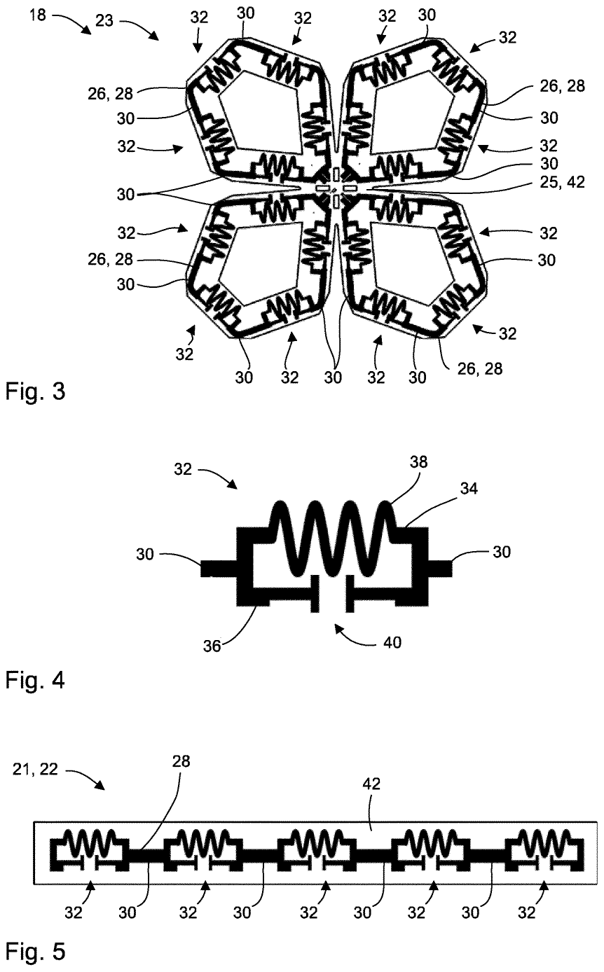

The head carrier 25 extends parallel to the reflector 20 and is shown in more detail in FIG. 3.

The radiation structures 26 are arranged in a 2×2 grid, wherein diagonally opposite radiation structures 26 form one dipole.

For example, the radiator head 23 is a dual-polarized dipole, in particular with one +45-degree and one −45-degree single-polarized dipole. Each single-polarized dipole comprises two dipole arms.

The filter carrier 42 is a substrate of a dielectric material. For example, the substrate is a printed circuit board.

It is also conceivable that the filter carrier 42 is one or more foils carrying the conductor 30 and the filter unit cells 32.

In the shown embodiment, the filter carrier 42 has two surfaces.

It is also conceivable that the filter carrier 28 is multilayered, e.g. a multilayered substrate. In this case, the filter carrier 28 comprises more than two surfaces. In multilayered substrates, inner surfaces may be referred to as layers. The words “layer” and “surface” are used interchangeable within this disclosure.

The conductor 30 and the filter unit cells 32 may be metallizations deposited on the respective surface of the filter carrier 42 using deposition techniques as known in the art.

With respect to the spatial filters 28 of the radiating structures 26, the filter carrier 42 is a portion of the head carrier 25. For example, the filter carriers 42 of all the spatial filters 28 of the radiating structures 26 form the entire head carrier 25.

Each of the radiating structures 26 comprises one spatial filter 28. In the shown embodiment, each radiating structure 26 is formed by the respective spatial filter 28.

The spatial filters 28 of the radiator head 23 are designed in the same way so that in the following only one spatial filter 28 is described.

The spatial filter 28 comprises a conductor 30 and a plurality of filter unit cells 32.

The conductor 30 is a single transmission line which, in case of the spatial filters 28 of the radiating structures 26, forms a closed loop.

The loop has a size and a shape of a radiating structure of a vector dipole as known in the art. In the shown embodiment, the loop has a pentagonal shape.

Within this loop, i.e. in the conductor 30, the filter unit cells 32 are arranged in series. The filter unit cells 32 are thus electrically, in particular galvanically connected via the conductor 30.

FIG. 4 shows an enlarged view of an exemplary filter unit cell 32.

Each filter unit cell 32 comprises a first arm 34 and a second arm 36, both extending from the conductor 30, extent electrically parallel to each other and then merge with conductor 30 again at the other end of the filter unit cell 32.

In the first arm 34, an inductive line 38 is located providing an inductance. The inductive line 38 has, in the embodiment shown in FIG. 4, a wave shape, in particular a sine wave shape.

The way shape has an amplitude and a periodicity. For example, the amplitude is about 4 mm to 5 mm and the periodicity is in the range of 3 to 5 periods per filter unit cell 32.

The inductance of the inductive line 38 may be changed by changing the amplitude, the periodicity and/or the width of the line of the wave shape.

In the second arm 36, a capacitor 40 is located providing a capacitance. In the embodiment shown in FIG. 4, the capacitor 40 is provided as a parallel plate capacitor.

The capacitance of the second arm 36 may be changed by changing the dimensions of the plates and/or the distance between the plates of the capacitor 40.

In the shown embodiment, all of the filter unit cells 32 of the spatial filters 28 of the radiating structures 26 are identical.

Turning back to FIG. 3, in the shown embodiment, each spatial filter 28 comprises five filter units cells 32. It is conceivable that the spatial filter 28 comprises more than five filter unit cells 32 to or less than five filter unit cells 32, for example four filter unit cells 32.

Further, each spatial filter 28 comprises a filter carrier 42 by means of which the conducting structures of the conductor 30 and the filter unit cells 32 are supported.

In the embodiment shown in FIG. 3, the entire conductor 30 and all of the filter unit cells 32 are on the same surface.

It is also conceivable that the spatial filter 28 comprises or is made of a single metal piece, in particular a stamped piece of sheet metal.

In this case the filter carrier 28 may be a thermoplastic part supporting the metal piece. The metal piece may also be self-supporting so that no filter carrier 28 is needed and/or provided.

By virtue of the filter unit cells 32 and the entire spatial filters 28, multiple resonances in the spatial filter 28 are provided for electromagnetic radiation in the second frequency band. As the effect, the spatial filters 28 and thus the entire radiating structures 26 are transparent for electromagnetic radiation in the second frequency band. As such, the first radiators 18 are transparent to the radiation of the second radiators 19 and cross-band scattering is suppressed.

In order to increase the transparency of the decoupling elements 22 with respect to electromagnetic radiation in the second frequency band, at least one of the spatial filters 28 is provided on each decoupling element 22, as shown in FIG. 5.

The filter carrier 42 of the spatial filters 28 at the decoupling elements 22 are, in particular, a portion or the entire carrier of the decoupling element.

The spatial filters 28 applied to the decoupling elements 22 differ from the spatial filters 28 of the radiators 18 in that the conductor 30 does not form a closed loop, but a line.

Nevertheless, the spatial filter 28 works in the very same way as described with respect to the spatial filters 28 of the radiating structures 26.

Further, the reflector 20 may also comprise spatial filters 28 (indicated schematically in FIG. 2) to increase its transparency for certain frequency bands.

It is also conceivable that the supports 24 of the first or second radiators 18, 19 comprise spatial filters 28 or any other component comprises spatial filters 28 to increase its transparency with respect to the second frequency band.

In the first embodiment, the filter unit cells 32 within the same spatial filter 28 and in fact across the entire antenna 14, 16 are the same. In particular, the filter unit cells 32 of the spatial filters 28 of the decoupling elements 22 are identical to the filter unit cells 32 of the spatial filters 28 of the radiating structures 26.

It is also conceivable, that the filter unit cells 32 of the same spatial filter 28 differ from one another, in order to increase the transparency across an even broader bandwidth.

It is further conceivable that the antenna 14, 16 comprises even third radiators forming a third array for a third frequency band. Thus, the third radiators are designed to transmit and receive electromagnetic waves in the third frequency band. The third array may be interleaved with the first and the second array.

In this case, the spatial filters 28 are transparent or increase the transparency of the radiation structures 26 and decoupling elements 22 also in the third frequency band.

The third frequency band lies above the first and second frequency band.

Even though the use of the spatial filters 28 has been discussed only with respect to the first radiator 18, i.e. the spatial filters 28 being transparent in the second and possibly a third frequency band, it is also conceivable that the second radiators 19 are provided with spatial filters 28 to increase their transparency for electromagnetic waves in other frequency bands, in particular the third frequency band.

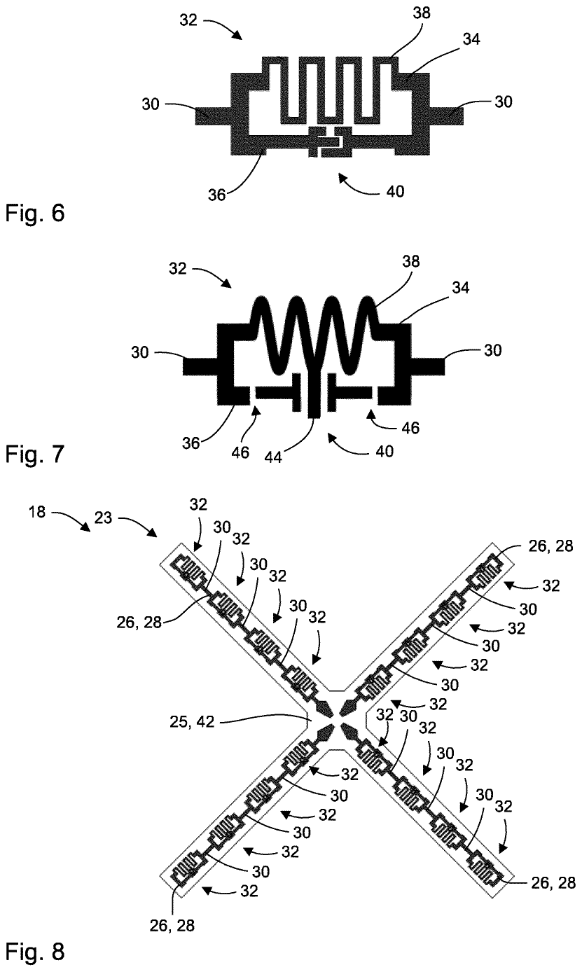

FIGS. 6 to 11 show further embodiments of components of an antenna according to the invention. They correspond substantially to the first embodiment so that only the differences are discussed in the following, and the same and functionally the same components are labeled with the same reference signs.

FIG. 6 shows a second embodiment of a filter unit cell 32 for a spatial filter 28. The filter unit cell 32 of this embodiment comprises a digital square wave shape as an inductive line 38 and an interdigital capacitor as a capacitor 14.

It is conceivable that components the filter unit cells 32 of the first embodiment (FIG. 4) and of the second embodiment (FIG. 6) are exchanged and combined.

FIG. 7 shows a third embodiment of a filter unit cell 32 in which the first arm 34 comprises a projection 44.

The projection 44 extends from the first arm 34 towards the second arm 36 and into the dielectric space of the capacitor, e.g. between the plates of the capacitor 14.

Further, in the second arm 36 two additional capacitances 46 are provided by gaps on either side of the capacitor 40.

The projection 44 increases the inductivity of the spatial filter 28 and the capacitances 46 increase the capacitance of the filter unit cells 32.

It is conceivable that only the projection 44 or the additional capacitances 44 are used and, e.g. applied to the first and second embodiment of the filter unit cell 32.

FIG. 8 shows a second embodiment of a radiator head 23 of an antenna 14, 16 according to the invention.

In this embodiment, the radiating structures 26 and thus the spatial filters 28 do not have a loop shape but are line shaped. Thus, a cross shaped dual polarized first radiator 18 is provided.

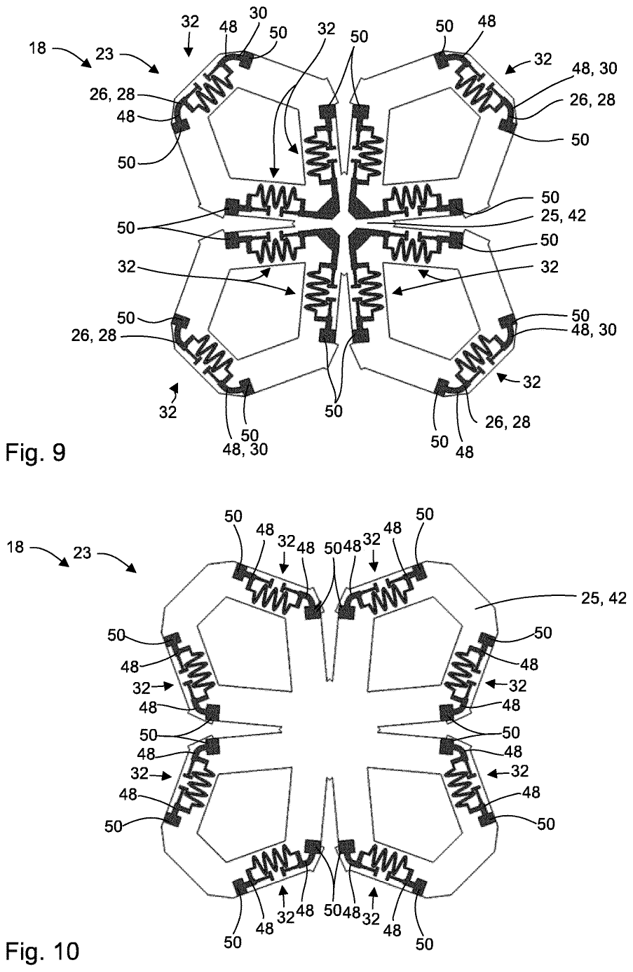

FIGS. 9 and 10 show a third embodiment of a radiator head 23 of an antenna 14, 16 according to the invention.

FIG. 9 shows a first surface of the radiator head 23, i.e. the head carrier 25, and FIG. 10 shows a second surface of the radiator head 23 opposite to the first surface.

It can clearly be seen that the spatial filters 28 extent on both surfaces (or layers) of the head carrier 25 and thus the filter carrier 42.

In the shown embodiment, the filter unit cells 32 are arranged on the first and second surface in an alternating fashion.

Likewise, the conductor 30 extends on the first surface as well as on the second surface.

The conductor therefore has a plurality of sections 48, each section 48 comprising one of the filter unit cells 32.

In the shown embodiment, the first, third and fifth section are located on the first surface, and the second and fourth section 48 are located on the second surface of the filter carrier 42.

At the end of each section 48, a patch area 50 is formed by the conductor 30, wherein the respective patch areas 50 of consecutive sections 48 overlap with one another in a vertical projection. In other words, the respective patch areas 50 are located directly above and below each other separated only by the filter carrier 42, thus providing a capacitive coupling between the respective sections 48.

This way, the conductor 30 still has a loop shape as all the sections 48 on both surfaces of the filter carrier 42 have to be considered.

Electrically, the conductor 30 differs from the conductor of the first embodiment only in the fact that capacitances are provided between each pair of adjacent filter unit cells 32.

Using this design, capacitances are easily provided in the conductor 30 further allowing the tuning of the frequency band in which the spatial filters 28 are transparent.

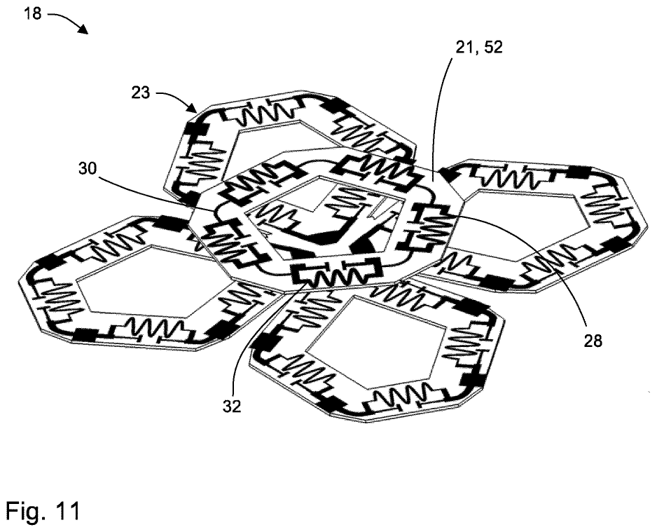

FIG. 11 shows a further embodiment of a first radiator 18 according to the invention. In this embodiment, the antenna 14, 16 comprises as one of the directional elements 21 a parasitic decoupling element 52.

In particular, a parasitic decoupling element 52 is provided for each first radiator 18-

The parasitic decoupling element 52 is located above the respective first radiator 18 and arranged concentrically with the respective first radiator 18.

The parasitic decoupling element 52 comprises a spatial filter 28 as discussed above, in particular the spatial filter 28 having a closed loop conductor 30.

The carrier of the parasitic decoupling element 52 is therefore formed by the filter carrier 42 of the respective spatial filter 28.

The filter carrier 42 may have a ring shape, i.e. an opening in its geometric center. In the shown embodiment, the parasitic decoupling element 52 has a pentagonal shape.

The parasitic decoupling element 52 improves the impedance matching of the respective radiator 18.

The shown embodiments are only examples, meaning that the features of the various embodiments may be exchanged and/or combined with one another.

1. An antenna, in particular for a mobile communication base station, comprising at least one first radiator for a first frequency band, at least one second radiator for a second frequency band and at least one spatial filter;
wherein at least one of the at least one spatial filter is a part of the at least one first radiator, at least one of the at least one spatial filter is part of a reflector of the antenna and/or at least one of the at least one spatial filter is part of a tuning element of the antenna;
wherein the at least one spatial filter comprises a conductor and filter unit cells as part of the conductor, the filter unit cells comprising a first arm, a second arm, an inductive line and a capacitor, wherein the inductive line is located in the first arm and the capacitor is located in the second arm.

2. The antenna according to claim 1, wherein the first arm and the second arm are both electrically connected, in particular galvanically connected, to the conductor.

3. The antenna according to claim 1, wherein the filter unit cells are arranged in series on the conductor.

4. The antenna according to claim 1, wherein the conductor forms a loop, in particular a closed loop.

5. The antenna according to claim 1, wherein the inductive line has a wave shape, in particular a sine wave shape or a digital square wave shape.

6. The antenna according to claim 1, wherein the capacitor is a parallel plate capacitor or an interdigital capacitor.

7. The antenna according to claim 1, wherein a projection of the first arm extends into the capacitor in the second arm, in particular wherein the projection is located in the middle of the first arm.

8. The antenna according to claim 1, wherein the spatial filter comprises or is made of a single metal piece, in particular a stamped sheet metal part.

9. The antenna according to claim 1, wherein the spatial filter comprises a filter carrier being a dielectric, in particular a foil, a printed circuit board or a thermoplastic part.

10. The antenna according to claim 9, wherein the filter unit cells of the same spatial filter are arranged on the same surface or layer of the filter carrier.

11. The antenna according to claim 9, wherein the filter carrier has at least two surfaces or layers, wherein the filter unit cells of the same spatial filter are arranged on both of the surfaces or layers and/or the conductor of the same spatial filter is arranged on both surfaces or layers.

12. The antenna according to claim 1, wherein the filter unit cells of the same spatial filter are identical or different from one another.

13. The antenna according to claim 1, wherein the at least one first radiator comprises at least one, in particular two or four radiating structures, wherein the radiating structures comprise one of the at least one spatial filter, in particular the one of the at least one spatial filter forms the respective radiating structure.

14. The antenna according to claim 1, wherein the tuning element is a parasitic decoupling element, in particular arranged above the at least one first radiator, and/or a decoupling element, in particular arranged between adjacent ones of the first radiators.

15. The antenna according to claim 1, wherein the antenna comprises a plurality of first radiators mounted to the reflector forming a first array and/or a plurality of second radiators mounted to the reflector forming a second array.

16. A mobile communication base station having at least one antenna comprising at least one first radiator for a first frequency band, at least one second radiator for a second frequency band and at least one spatial filter;
wherein at least one of the at least one spatial filter is a part of the at least one first radiator, at least one of the at least one spatial filter is part of a reflector of the antenna and/or at least one of the at least one spatial filter is part of a tuning element of the antenna;
wherein the at least one spatial filter comprises a conductor and filter unit cells as part of the conductor, the filter unit cells comprising a first arm, a second arm, an inductive line and a capacitor, wherein the inductive line is located in the first arm and the capacitor is located in the second arm.

17. A user device for mobile communication having at least one antenna comprising at least one first radiator for a first frequency band, at least one second radiator for a second frequency band and at least one spatial filter;
wherein at least one of the at least one spatial filter is a part of the at least one first radiator, at least one of the at least one spatial filter is part of a reflector of the antenna and/or at least one of the at least one spatial filter is part of a tuning element of the antenna;
wherein the at least one spatial filter comprises a conductor and filter unit cells as part of the conductor, the filter unit cells comprising a first arm, a second arm, an inductive line and a capacitor, wherein the inductive line is located in the first arm and the capacitor is located in the second arm.
